(19) United States
(12) Patent Application Publication
(10) Pub. No.: US 2020/0284749 A1
(43) Pub. Date: Sep. 10, 2020

(54) Technologies Using Pseudo-Graphite Composites

(71) Applicants: ABB Schweiz AG, Baden (CH); University of Idaho, Moscow, ID (US)

(72) Inventors: Nolan Nicholas, Granby, CT (US); Ignatius Cheng, Moscow, ID (US); Haoyu Zhu, Moscow, ID (US); Humayun Kabir, Moscow, ID (US); Hamal Kailash, Moscow, ID (US); Jeremy May, Moscow, ID (US)

(21) Appl. No.: 16/292,322

(22) Filed: Mar. 5, 2019

(51) Int. Cl. G01N 27/30; B41M 3/00

(52) U.S. Cl. CPC G01N 27/308; B41M 3/006

(57) ABSTRACT

Methods, electrodes, and electrochemical devices using pseudo-graphite composites are disclosed. In one illustrative embodiment, a method may include forming a composite material comprising pseudo-graphite. The method may further include depositing the composite material onto a surface of an electrode substrate to produce an electrode having a composite pseudo-graphite surface.

### CROSS-REFERENCE TO RELATED APPLICATIONS

This application is related to U.S. Patent Application Serial Nos. ______ (titled “Chemical Oxygen Demand Sensing Using Pseudo-Graphite”), ______ (titled “Chlorine Species Sensing Using Pseudo-Graphite”), ______ (titled “pH Sensing Using Pseudo-Graphite”), ______ (titled “Technologies Using Nitrogen-Functionalized Pseudo-Graphite”), and ______ (titled “Technologies Using Surface-Modified Pseudo-Graphite”), all of which were filed on Mar. 5, 2019, by the co-applicants of the present application. The disclosures of the foregoing patent applications are all incorporated herein by reference in their entirety.

### BACKGROUND

The present disclosure relates to technologies using pseudo-graphite composites, and more particularly to the utilization of electrodes with pseudo-graphite composites for performing electrochemical operations such as for detecting chemical species.

Generally, some electrodes in a sensor are capable of detecting chemical species, for example, chemical species in a liquid. The electrodes may be utilized to detect a concentration of chemical species in the liquid by applying a potential across the electrode and measuring a resultant signal. However, most chemical detection electrodes have a high cost and may produce a low performance. Additionally, the electrode performance may be reduced due to fouling of the electrode or environmental interferences.

### SUMMARY

The present disclosure includes one or more of the features recited in the appended claims and/or the following features which, alone or in any combination, may comprise patentable subject matter.

According to an aspect of the disclosed embodiments, a method may include forming a composite material comprising pseudo-graphite. The method may also include depositing the composite material onto a surface of an electrode substrate to produce an electrode having a composite pseudo-graphite surface.

In some embodiments, the composite material is formed from particulated pseudo-graphite. Forming the composite material may include oxidizing the pseudo-graphite to form an oxidized composite material. The method may also include reducing the oxidized composite material. Forming the composite material may include forming at least one of aminated pseudo-graphite, carboxylated pseudo-graphite, methylated pseudo-graphite, alkylated pseudo-graphite, phenylated pseudo-graphite, benzylated pseudo-graphite, cyclopropenoid pseudo-graphite, carbene-oid derivatized pseudo-graphite, ferrocene-functionalized pseudo-graphite, and PEG-ylated pseudo-graphite.

Optionally, the composite material may include a mixture of pseudo-graphite and a polymeric material. The composite material may include a mixture of pseudo-graphite and a ceramic material. The composite material may include a mixture of pseudo-graphite and a fluorinated polymeric material. The composite material may include a mixture of pseudo-graphite, a secondary material, and a porosity-imparting material. The composite material may include a mixture of pseudo-graphite and a silicon-containing material. The composite material may include a mixture of pseudo-graphite and an oil material. The composite material may include a mixture of pseudo-graphite and a conductive material.

Alternatively or additionally, the method may include modifying the pseudo-graphite through etherification. The method may also include modifying the pseudo-graphite through unsaturated pendant group binding. The method may also include modifying the pseudo-graphite through shell-functionalization. The method may also include modifying the pseudo-graphite through non-covalent decoration. Forming the composite material may include chemically linking a binder to the pseudo-graphite. Depositing the composite material onto a surface of an electrode substrate may include depositing the composite material onto a non-conducting substrate to form electrodes and traces. Depositing the composite material onto a non-conducting substrate may include screen-printing the composite material onto the non-conducting substrate.

According to another aspect of the disclosed embodiments, an electrochemical device may include a working electrode including a composite material having pseudo-graphite. An electrical source may supply at least one of a current or voltage to the working electrode.

In some embodiments, the composite material may be formed through at least one of oxidation, etherification, unsaturated pendant group binding, shell-functionalization, or non-covalent decoration. The composite material may include at least one of aminated pseudo-graphite, carboxylated pseudo-graphite, methylated pseudo-graphite, alkylated pseudo-graphite, phenylated pseudo-graphite, benzylated pseudo-graphite, pseudo-graphite modified by a diamond-like surface layer, cyclopropenoid pseudo-graphite, carbene-oid derivatized pseudo-graphite, ferrocene pseudo-graphite, PEG-ylated pseudo-graphite, or functionalization rexn pseudo-graphite. The composite material may be formed from particulated pseudo-graphite. The electrochemical device may be a sensor including a measurement circuit to measure a resultant signal from the working electrode. The composite material may be at least one of a mixture of pseudo-graphite and a polymeric material, a mixture of pseudo-graphite and a ceramic material, a mixture of pseudo-graphite and a fluorinated polymeric material, a mixture of pseudo-graphite and a silicon-containing material, a mixture of pseudo-graphite and an oil material, a mixture of pseudo-graphite and a grease material, a mixture of pseudo-graphite and an acid, a mixture of pseudo-graphite and a conductive material, or a mixture of pseudo-graphite, a secondary material, and a porosity-imparting material.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. The detailed description particularly refers to the accompanying figures in which:

FIG. 1 is a simplified block diagram of a sensor device in accordance with an embodiment;

FIG. 2 is a cross-sectional view of the working electrode shown in FIG. 1;

FIG. 3 is a simplified flowchart of a method for a compositing process to produce particulated pseudo-graphite material:Nafion at 88.4:11.6 wt % (20-99 wt % particle loading range);

FIG. 4 is a simplified flowchart of a method for a compositing process to produce pseudo-graphite material coated K1 glass bubbles:PTFE at 98:2 (by mass);

FIG. 5 is a simplified flowchart of a method for a compositing process to produce diatomaceous pseudo-graphite material:Silicone Oil=90:10 (by mass);

FIG. 6 is a simplified flowchart of a method for a compositing process to produce diatomaceous pseudo-graphite material:Paraffin Oil=90:10 (by mass);

FIG. 7 is a simplified flowchart of a method for a compositing process to produce diatomaceous pseudo-graphite material:Vacuum Grease=90:10 (by mass);

FIG. 8 is a simplified flowchart of a method for a compositing process to produce pseudo-graphite material coated K1 glass bubbles (3M):Paraffin oil=1:1 (by mass);

FIG. 9 is a simplified flowchart of a method for a compositing process to produce pseudo-graphite material+Nafion+Na₂SO₄ nanowires for etch/leach of 25 mg of particulated pseudo-graphite material;

FIG. 10 is a simplified flowchart of a method for a compositing process to produce pseudo-graphite material+Nafion+for substoichiometric Naphthalenide reduction;

FIG. 11 is a simplified flowchart of a method for a compositing process to produce pseudo-graphite material+Teflon AF+polyethylene oxide for phase segregated ion conductive PEO;

FIG. 12 is a simplified flowchart of a method for a compositing process to produce aiminated pseudo-graphite material+PolyAcrylic Acid for amide linkages;

FIG. 13 is a simplified flowchart of a method for a compositing process to produce porous fused glass pseudo-graphite material monolith electrode (binderless);

FIG. 14 is a simplified flowchart of a method for a compositing process to produce halloysite clay pseudo-graphite material monolith electrode (binderless);

FIG. 15 is a simplified flowchart of a method for a compositing process to produce pseudo-graphite material+CYTOP+1,6bis(trichlorosilyl)hexane;

FIG. 16 is a simplified flowchart of a method for a compositing process to produce pseudo-graphite material+Nafion with electrochemical reductive crosslinking; and

FIG. 17 is a schematic of an electrochemical device in accordance with an embodiment.

### DETAILED DESCRIPTION OF THE DRAWINGS

While the concepts of the present disclosure are susceptible to various modifications and alternative forms, specific embodiments thereof have been shown by way of example in the figures and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Referring to FIG. 1, in one illustrative embodiment, a sensor device 10 includes an electrochemical cell 12 configured to be positioned within a liquid having a chemical species. The electrochemical cell 12 houses a working electrode 14, a counter electrode 16, and a reference electrode 18. In some embodiments, the electrochemical cell 12 only houses the working electrode 14 and the counter electrode 16, and does not include a reference electrode 18. In other embodiments, the reference electrode 18 and working electrode 14 may be combined into a single electrode. The working electrode 14 is electrically coupled to a source 30. The source 30 may be a current source or a voltage source. Each electrode 14, 16, 18 is coupled to a measuring circuit 32 that is configured to measure current or voltage, depending on the type of source 30.

In an embodiment where the source 30 is a current source, the source 30 applies a known current to the working electrode 14. The measuring circuit 32 detects a resultant current between the working electrode 14 and the counter electrode 16. By comparing the resultant current to a current at the reference electrode 18, a concentration of chemical species in the liquid may be detected.

In an embodiment where the source 30 is a voltage source, the source 30 applies a known voltage to the working electrode 14 that is held at a controlled potential relative to a reference. The measuring circuit 32 detects a resultant voltage or current between the working electrode 14 and the counter electrode 16. By comparing the resultant voltage to a voltage at the reference electrode 18, a concentration of chemical species in the liquid may be detected.

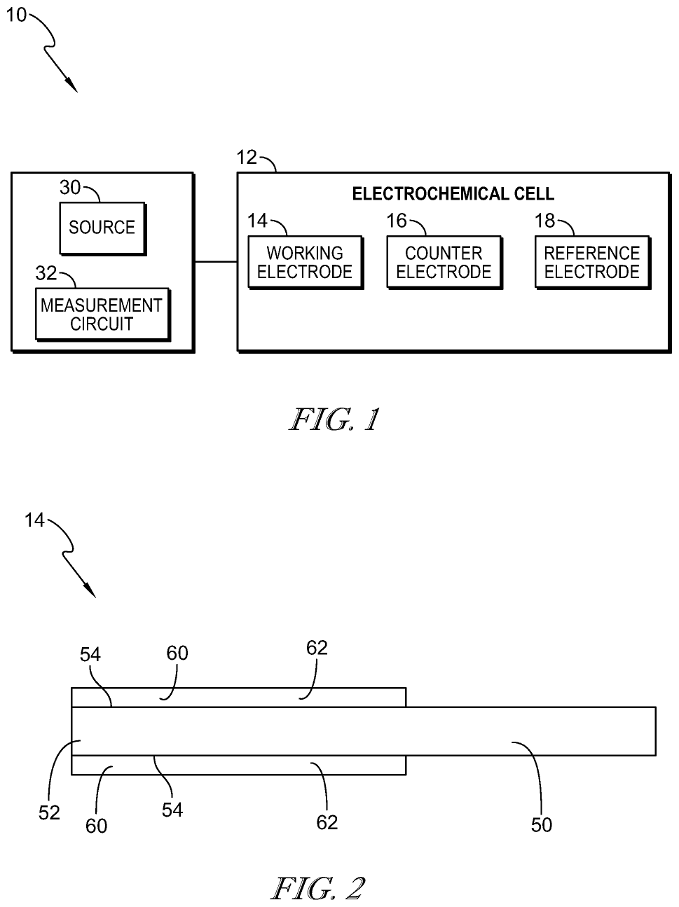

Referring now to FIG. 2, in one illustrative embodiment, the working electrode 14 includes a substrate 50 having at least one surface 52 with a coatable surface 54. In some embodiments, the electrode 14 is a composite electrode. The coatable surface 54 may be selected from at least one of nanosprings, nanotubes, diatomites, a metal, glass, mica, germanium, and silicon (including porous high surface area electrochemically etched silicon). The metal may be selected from copper or iron. The coatable surface 54 may possess suitable thermal stability, chemical stability at fabrications temperatures and surface chemistry to have a pseudo-graphite applied thereon. The coatable surface 54 may also have relatively low thermal expansion between the deposition conditions and room temperature. For synthesis/fabrication purposes this includes stable ceramics such as SiO₂ (which includes micro- and nano-sized structures such as nanosprings and diatomites), as well as other ceramics like Al₂O₃ (including halloysite and anodized aluminum oxide membranes), MgO, iron oxides, silicon, cenospheres, and the like. It also includes suitable carbons such as graphite fibers and carbon black and some high temperature tolerant metals such as tungsten and molybdenum. A pseudo-graphite 54 is coated onto the surface 52 of the substrate 50. The illustrative embodiment shows the pseudo-graphite 54 coated on two surfaces 52 of the substrate 50. In some embodiments, the pseudo-graphite is only coated on a single surface 52 of the substrate 50. In some embodiments, the pseudo-graphite 54 is coated around the substrate 50. The pseudo-graphite 54 may be modified with an electrochemically sensitive material 62 to alter a sensing property of the electrode 14 to enhance the electrode 14 for free chlorine species detection.

As used in the present disclosure, “pseudo-graphite” refers to an allotrope of carbon that is graphite-like, but that has one or more improved properties as compared to graphite and to graphene. These improved properties may include fast heterogeneous electron transfer (HET) at a basal plane of the pseudo-graphite and/or corrosion resistance greater than graphite and graphene. In some embodiments, the pseudo-graphite may be a nanocrystalline-graphite that is in Stage-2 of Ferrari's amorphization trajectory between amorphous carbon and graphite. In some embodiments, the pseudo-graphite has a nanocrystallite size of 1.5 nm, as measured by X-Ray Diffraction (XRD). The pseudo-graphite may have a layered morphology but, in contrast to graphites and graphenes, has a resistance to monoloyer exfoliation. Instead, pseudo-graphite typically exfoliates in thick films of several hundred monolayers at a time.

In some embodiments, the pseudo-graphite may have a sp2/sp3 carbon ratio of about 85/15. In other embodiments, the carbon content of the pseudo-graphite may include between 80-90% sp2 carbon and 10-20% sp3 carbon. In still other embodiments, the carbon content of the pseudo-graphite may include between 75-95% sp2 carbon and 5-25% sp3 carbon. By contrast, typical graphites and graphenes both are near 100% sp2 carbon. For clarity, the pseudo-graphite can contain additional elements besides carbon. For instance, some pseudo-graphites include about 11 atomic % hydrogen.

The appearance of pseudo-graphite may be similar to a crystalline graphite but differs in that both the basal and edge planes (EP) have facile heterogeneous electron transfer (HET) kinetics. The basal plane (BP) of graphites have a barrier to HET as these materials are zero-band gap semiconductors. On the other hand, structural defects within the molecular planes of BP pseudo-graphite may increase density of electronic states (DOS) near the Fermi-level with corresponding HET rates. With the Fe(CN)₆^{3-/4-}redox probe, BP and EP pseudo-graphite have achieved a standard HET rate)(k⁰) of 10⁻² cm/s. Other distinguishing features can include slow hydrogen evolution kinetics and/or molecular planes that are impervious to sub-surface electrolyte intercalation, making the pseudo-graphite more resistant to corrosion than graphites and graphenes. These features can provide a wide electrochemical potential window of 3 V at 200 μA/cm² in 1 M H₂SO₄, which surpasses other sp2 carbon electrodes by 1 V and provides pseudo-graphite similar properties to boron-doped diamond.

Illustrative examples of “pseudo-graphite,” and methods of producing such materials, are disclosed in each of U.S. Pat. No. 9,691,556, U.S. Patent Application Publication No. 2012/0228555, and Humayun Kabir et al., “The sp2-sp3 carbon hybridization content of nanocrystalline graphite from pyrolyzed vegetable oil, comparison of electrochemistry and physical properties with other carbon forms and allotropes,” published in Carbon, volume 144, pages 831-840. The entire disclosures of each of the foregoing references are incorporated herein by reference. In some embodiments, pseudo-graphite may also include nitrogen-doped pseudo-graphite.

The pseudo-graphite material used to form the presently disclosed composite electrodes may be un-modified “native” pseudo-graphite material or it may be chemically modified (or a combination thereof). The fabrication of electrodes from pseudo-graphite-based mixtures provides advantages for the resulting electrodes relating to both ease and cost of production and also to the performance of the electrodes thus formed. Specifically, the fabrication of composite electrodes from particulated pseudo-graphite material enables the lower cost nature of the fabrication of particulated pseudo-graphite material and the fabrication of pseudo-graphite electrodes on relatively low cost electrodes, such as printed circuit board electrodes, that do not have to be able to withstand the conditions for direct chemical vapor deposition of pseudo-graphite material. The deposition of such particulated composite electrodes may be accomplished by a variety of methods including inkjet printing, screen printing, gravure printing, drop-coating, and spray coating.

The pseudo-graphite material possesses many advantageous electrochemical properties as an electrode material. However, the fabrication of electrodes which are composites of pseudo-graphite material and one or more other materials may be utilized to simplify and reduce the cost of electrode fabrication and may also be utilized to improve the range of functionality and efficacy of pseudo-graphite-based electrodes for various applications.

Such electrodes can be formed from a mixture of particulated pseudo-graphite material along with one or more additional materials. These materials may be dispersed together in a liquid phase which can then be deposited onto an underlying substrate. This will then commonly be dried of the dispersant fluid to form a solid or quasi-solid composite electrode body.

The use of particulated pseudo-graphite material is advantageous from a production cost perspective. Generally, pseudo-graphite material is produced by a chemical vapor deposition process which coats a film of pseudo-graphite material onto suitable deposition substrate surfaces. Thus the amount of pseudo-graphite material produced by a particular synthesis is proportional to the amount of surface area available for deposition. To make particulated pseudo-graphite material high-surface-area substrates may be used to maximize the yield of pseudo-graphite material available for making electrodes. Such high-surface-area substrates may take several forms. For example, pseudo-graphite material is deposited onto materials which exist as substantially individual particles. A wide variety of materials can be used as such a substrate with the conditions that the surface is compatible with the deposition of the pseudo-graphite material and that the material withstands the deposition conditions, for example, temperature. Examples of such materials include diatoms, halloysite, silica nanowires and silica nanosprings, MgO nanoparticles and nanowires, tungsten nanowires, glass microspheres, chopped carbon fiber, and Na₂SO₄ or K₂SO₄ microparticles, nanoparticles, or nanowires, alumina nanotubes or nanowires, titania nanowires, etc.

Pseudo-graphite material can be formed on such particulate substrates in a variety of chemical vapor deposition conditions including fixed particle bed or fluidized bed reactors. The particulate substrates may be used with the substrate material incorporated into the composite electrode, for example, as pseudo-graphite material over-coated particles. In other embodiments, the deposition substrate may be removed to produce particulated pseudo-graphite material which is free of a deposition substrate. One way that substrates may be removed is selective chemical leaching by a variety of method and chemistries as are known in the art and applicable to the various substrates which may be chosen. For example, siliceous substrates such as diatoms, glass microspheres, and silica nanosprings can be removed by etching with HF. Magnesium oxide can be dissolved by acidic solutions such as aqueous hydrochloric acid. K₂SO₄ and Na₂SO₄ can be dissolved by water. In some embodiments, a step is incorporated during or prior to the etching/leaching step to introduce openings in the pseudo-graphite material coating through which the underlying substrate is exposed to the leaching environment.

Pseudo-graphite material is deposited onto monolithic or semi-monolithic materials which have a high surface area per apparent volume. Once the surface area of such a porous material is coated in pseudo-graphite material, it can be broken down into smaller parts, for example, by milling, to form particulated pseudo-graphite material bodies. In some embodiments, these substrates may be used with the substrate material incorporated into the composite electrode, for example, as pseudo-graphite material over-coated particles. In other cases, the deposition substrate may be removed to produce particulated pseudo-graphite material, which is free of a deposition substrate by methods such as are described above for the particulate deposition substrates.

A number of chemistries may be used to modify the pseudo-graphite material to produce a wide variety of surface groups and mixtures thereof. Such groups include but are not limited to hydroxyls, quinones, alkyls, lactones, carboxyls, epoxides, ethers, ozonides, amines, amides, imides, halides, sulfonates, etc. In some embodiments, catalytic species may be bound to the pseudo-graphite material surface including species such as enzymes, phthalocyanines, etc. In various embodiments, this may be used for imparting particular electrochemical functionalities to the resulting electrode.

Such functionalities may include interconvertable hydroxyl/quinonic functionalities to provide pH responsive electrochemical characteristics, amine functionalities to provide enhanced oxygen reduction reaction, various functionalities to provide anchoring moieties for further interaction or bonding with the other non-pseudo-graphite materials in the composite.

The pseudo-graphite material may be functionalized to be bonded directly to one or more of the other materials that form the composite electrode. Covalent bonds may be formed directly between the pseudo-graphite material and a compositing species of the pseudo-graphite material; such as a C—C covalent bond between a halogenated polymer and the pseudo-graphite material during partial reductive dehalogenation. This can be used to stabilize the molecular structure of the resulting composite. For instance, covalent bonds may be formed between carboxylated pseudo-graphite material and polyvinyl alcohol through the formation of ester bonds. Covalent bonds may be formed between carboxylated pseudo-graphite and polyethyleneimine to form amide bonds. Covalent bonds may be formed between aminated pseudo-graphite and poly(methyl vinyl ether-alt-maleic anhydride) to form imide bonds. To form composite electrodes from chemically modified pseudo-graphite material the modification may be performed prior to compositing, during compositing, after compositing or at multiple points throughout the process of fabricating the composite electrode.

Various methods may be used for chemically modifying pseudo-graphite material prior to the compositing process using methods such as electrochemical modification and/or using bulk-phase chemical reactions to modify the pseudo-graphite material surface and/or near-surface chemistry. Various electrochemical and bulk phase chemistries may be used for introducing a variety of surface moieties such as hydroxyls, carboxyls, quinonic oxygens, epoxides, ethers, ozonides, halides, amines, sulfonates, and various C—C bonded moieties.

The pseudo-graphite material may also be chemically modified during the compositing process by utilizing a process wherein the pseudo-graphite material reacts directly with one or more components in the composite during some portion of the mixing or forming phase. For instance, carboyxlated pseudo-graphite material may be mixed with polyvinyl alcohol in the presence of a catalytic strong acid to form ester bonds during the mixing process. In another example, epoxidized pseudo-graphite material may be mixed with a solution containing polyethyleneimine to form amide linkages between the pseudo-graphite material and the polyethyleneimine.

The pseudo-graphite material may also be chemically modified after the compositing process by utilizing a process wherein the pseudo-graphite material composite is subjected to conditions which produce further chemical modifications to the pseudo-graphite material composite chemistry. For instance, treatment of pseudo-graphite material-Nafion composites with substoichiometric amounts of reductive etching chemicals, such as FluoroEtch, may be used to create cross-links within the pseudo-graphite material-Nafion chemical structure and stabilize the resulting composite molecular structure. In some embodiments, the pseudo-graphite material-composite structure may be altered after composite formation through the application of localized high energy inputs such as focused laser energy, such as with CYTOP composites, spark welding, coupling to a high energy microwave/RF field, or plasma discharge. In other embodiments, the pseudo-graphite material composite structure may be chemically altered through electrochemical methods.

In some cases the other components of the pseudo-graphite material composite may be modified after forming the composite without significantly altering the chemistry of the pseudo-graphite material. For instance, spin-on-glass, for example, a polysiloxane in an organic solvent such as IC1-200 in butanol, is mixed with pseudo-graphite material in diluting solvent and cast and then fired with a temperature profile appropriate to cure the spin-on-glass.

The fabrication of electrodes from pseudo-graphite material-based mixtures provides advantages for the resulting electrodes relating to both ease and cost of production and also to the performance of the electrodes thus formed. Specifically, the fabrication of composite electrodes from particulated pseudo-graphite material enables the lower cost nature of the fabrication of particulated pseudo-graphite material and the fabrication of these electrodes on relatively low cost substrates, such as printed circuit board electrodes, that do not have to be able to withstand the conditions for direct chemical vapor deposition of pseudo-graphite material. The deposition of such particulated composite electrodes may be accomplished by a variety of methods at low cost including inkjet printing, screen printing, gravure printing, drop-coating, and spray coating. Furthermore, such methods may be used for the production of electrode devices wherein fine geometric detail (sub-mm) may be incorporated into the electrode structures and multiple electrodes may be fabricated onto the same substrate surface to incorporate multiple electrochemical functionalities into a single integrated substrate or ‘chip’. Furthermore, such particulated electrodes may be utilized to form high available surface area electrodes in applications where this is advantageous.

In some embodiments, composite electrodes may also be used to form ‘regenerable’ electrodes wherein the electrode surface may be wiped or polished to expose new “fresh” electrode surface. This may be accomplished through the incorporation of pseudo-graphite material into a matrix of a ‘grease’ that prevents electrochemical transport into the interior of the electrode and which may be readily removed by mechanical action to reveal new, ‘fresh’ pseudo-graphite material that has not previously been exposed to electrochemical activity. Materials suitable to act as such a ‘grease’ include paraffin waxes and grease, silicone oils and greases, chlorotrifluorocarbon oils, waxes and greases, etc.

Additionally, the use of particulated pseudo-graphite material composite electrodes enables electrode functionalization (e.g. for electrochemical sensing sensitivity/selectivity enhancement) to be performed by means of bulk chemical treatments of the precursor materials followed by the construction of these materials into multiple types of electrodes on the same substrate chip to include multiple functionalities onto the same device while facilitating the ease and low cost of the fabrication process. Such bulk chemical treatments typically provide a lower cost option than individual component treatment cost methods.

A variety of additional materials may be utilized in conjunction with pseudo-graphite material to form such composite electrodes. In some embodiments, a single additional material may be used while in other cases a plurality of additional materials may be used. Most commonly at least one of the additional materials will act as a binder for the composite electrode system. Binders will enable the composite electrode to hold together and impart durability to the electrode. Common examples include organic binders such as halogenated polymers, such as PTFE, PVDF, PCTFE, Teflon AF, CYTOP, Nafion, etc., hydrocarbon polymers, silicone polymers, such polymers commonly include low molecular weight polymers such as greases and waxes, polyethers, such as polyethylene oxide, or other binder polymers such as carboxymethyl cellulose, polyacrylic acid, polyethyleneimine, nitrocellulose, etc. Binders may also include inorganic species such and/or species that form inorganic binder species when processing is applied such as spin-on glass, silicon alkoxides, aluminum alkoxides, sodium silicate, etc. Binders may also include hybrids and mixtures thereof. Moreover, the functionality of a particular binder may be chosen with reference to the properties of the binder material according to the particular use intended for the electrode relating properties such as the electrochemical stability window, solvent/electrolyte permeability, electrical polarizability, physical & chemical stability, for example, thermal & pH stability, redox reactions, molecular structure stability, for example, whether the molecular lattice is significantly prone to re-organization under environmentally anticipated conditions which will be correlated so such properties as the T_{g} for a polymer.

Electrode materials may be incorporated into the composite to provide additional pathways for the flow of electrical current. Such materials include carbon conductive materials such as graphene, carbon nanotubes, and carbon black; metallic conductive materials including nanoparticles and nanowires of metals; and organic conductive materials such as molecular conductors and conducting polymers including nanoparticles and nanowires thereof; and oxide conducting particles including nanoparticles and nanowires thereof.

Sacrificial materials may be incorporated at some stage during the composite forming process but which are removed from the composite during a later stage of the composite electrode forming process. Sacrificial materials provide functions such as imparting porosity within the composite electrode, particularly interconnected porosity. Sacrificial materials sometimes provide an enhanced adhesion prior to curing/firing. Sacrificial materials may include a variety of material types including: blowing agents, decomposable binders, leachable materials, oxidizable materials, etc. Blowing agents include such materials as dissolved CO₂, and carbonates such as ammonium carbonate, etc. Decomposable binders include polymers such as polyalkylene carbonates, such as QPAC®40. Leachable materials include materials such as dissolvable salts, materials that will react with solutions to form dissolvable salts, such as oxides, for example, MgO, or metals which will react with aqueous acids to form dissolved salts) or materials such as selectively dissolvable polymers, such as polyacrylic acid. Oxidizable materials include materials that may be oxidized through direct or electrochemical means such and include materials such as celluloses, oxalates, etc. In some embodiments, such materials may take the form of micro- or nano-dimensioned and/or high aspect ratio structures. Examples of such particular forms of materials are diatomites, halloysite, silica nanowires, silica nanosprings, tungsten nanowires, MgO nanowires, MgO nanoparticles, sodium sulfate nanowires, potassium sulfate nanowires, nanocellulose, etc. In some embodiments, materials can be used which undergo intimate mixing during liquid dispersion/solubilization steps but which will undergo demixing during later processing. For instance, the use of polymeric binder compositions such as both polyacrylic acid and Nafion dispersed in water/alcohol mixtures can be used to cast binders that will undergo further segregation if processed at elevated temperatures after casting and wherein the polyacrylic will phase segregate from the Nafion and may then be more effectively leached from the composite electrode. Use of sacrificial materials within the composite may be accomplished through the mixing of these materials into the composite during or prior to deposition and then after deposition processing the resulting composite electrode under conditions suitable to remove the sacrificial material from the composite electrode.

Functionality imparting materials provide specific electrode functionality into the composite electrode. Such functionalities include imparting well defined redox reactions, providing enhanced and/or selective species transport through the material, providing catalytic action, or providing other specific physical and/or chemical responsiveness for the material. Examples of species that impart well-defined redox reactions include ferrocene and ferrocene derivatives including polymeric ferrocene derivatives, silver:silver-chloride nanoparticles, CeO₂₋ₓ nanoparticles, for example, with diameters in the range of 10-20 nm, etc. Examples of species that impart species specific transport through the material include Nafion, etc. Examples of materials that provide catalytic action include phthalocyanines, porphyrins, metal nanoparticles, enzymes, etc.

In some embodiments, the particulated pseudo-graphite material may have a high-aspect-ratio geometric form to maximize the conductivity of the resulting composite. In some embodiments, the ratio of pseudo-graphite material to other materials will be greater than 1:1 and will often be greater than 10:1. In some embodiments, high-aspect-ratio pseudo-graphites may be produced by deposition onto high-aspect-ratio substrate particulates such as nanorods, nanowires, etc. In an example embodiment, pseudo-graphite may be deposited with a thickness of approximately 50 nm onto magnesium oxide nanorods with dimensions of approximately 20 nm in diameter and 1 μm in length and then these nanorods are processed in dilute aqueous hydrochloric acid solution with sodium dodecylbenzene sulfonate under the action of bath sonication to remove the nanorod template and leave behind a high-aspect ratio pseudo-graphite ‘nanotube’.

Particulated pseudo-graphite material include powders produced by mechanical abrasions i.e ball milling, grinding, sonication or by CVD onto templates. These include any template that can withstand the process of chemical vapor deposition. These include glass, silica, metals, metal alloys, semimetals, semimetal oxides and metal oxides and salts which are capable of withstanding deposition conditions.

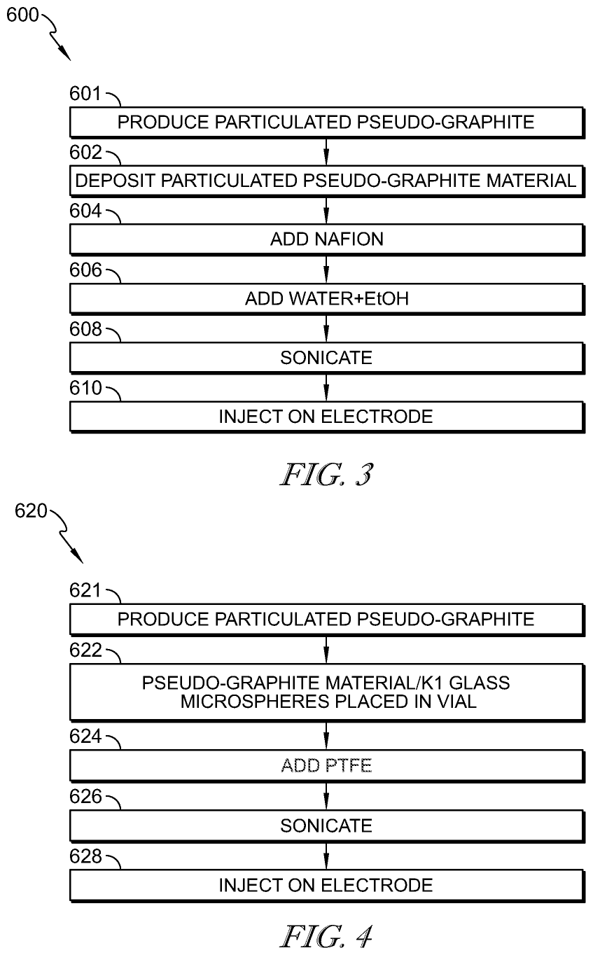

FIG. 3 illustrates a method 600 for a compositing process to produce particulated pseudo-graphite material:Nafion at 88.4:11.6 wt % (20-99 wt % particle loading range). At block 601, particulated pseudo-graphite is produced. At block 602, 25 mg particulated pseudo-graphite material is deposited. At block 604, 75 μL Nafion (5.0 wt %) is added. At block 606, 50 μL 50:50 mixture of Water+EtOH is added. At block 608, the mixture is sonicated for approximately 5 min in a bath sonicator. At block 610, 5 μL of the suspension is injected on a glassy carbon electrode.

FIG. 4 illustrates a method 620 for a compositing process to produce pseudo-graphite material coated K1 glass bubbles:PTFE at 98:2 (by mass). At block 621, particulated pseudo-graphite is produced. At block 622, 18 mg pseudo-graphite material/K1 glass microspheres are placed in a vial. At block 624, 400 μL of PTFE (60 wt %) is added. At block 626, the mixture is sonicated for approximately 5 min in a bath sonicator. At block 628, 5 μL of the suspension is injected onto an electrode, for example a glassy carbon electrode.

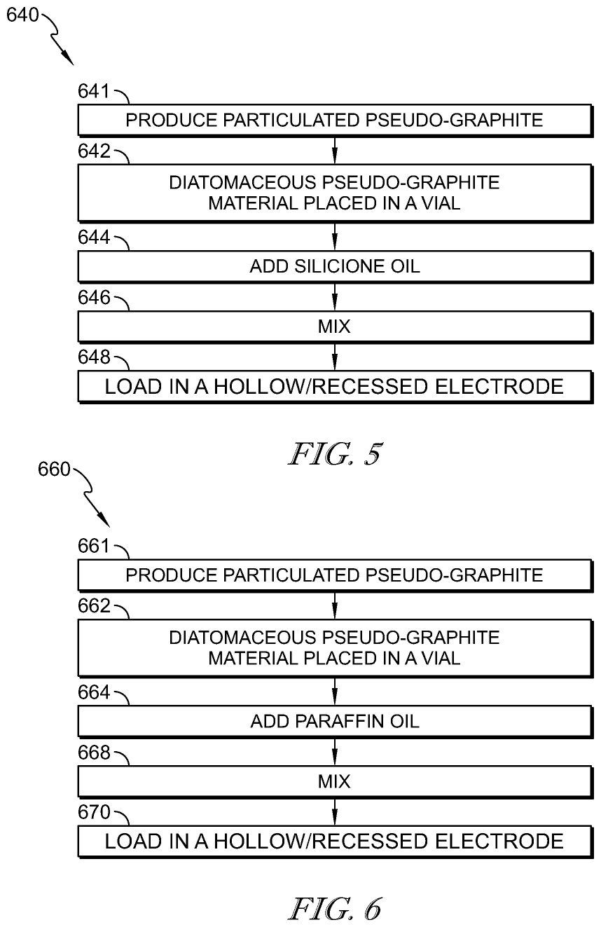

FIG. 5 illustrates a method 640 for a compositing process to produce diatomaceous pseudo-graphite material:Silicone Oil=90:10 (by mass). At block 641, particulated pseudo-graphite is produced. At block 642, 45 mg diatomaceous pseudo-graphite material is placed in a vial. At block 644, 5 mg of silicone oil is added. At block 646, the mixture is mixed for approximately 5 min. At block 648, the mixture is loaded in a hollow/recessed electrode.

FIG. 6 illustrates a method 660 for a compositing process to produce diatomaceous pseudo-graphite material:Paraffin Oil=90:10 (by mass). At block 661, particulated pseudo-graphite is produced. At block 662, 45 mg diatomaceous pseudo-graphite material is placed in a vial. At block 664, 5 mg of paraffin oil is added. At block 668, the mixture is mixed for approximately 5 min. At block 670, the mixture is loaded in a hollow/recessed electrode.

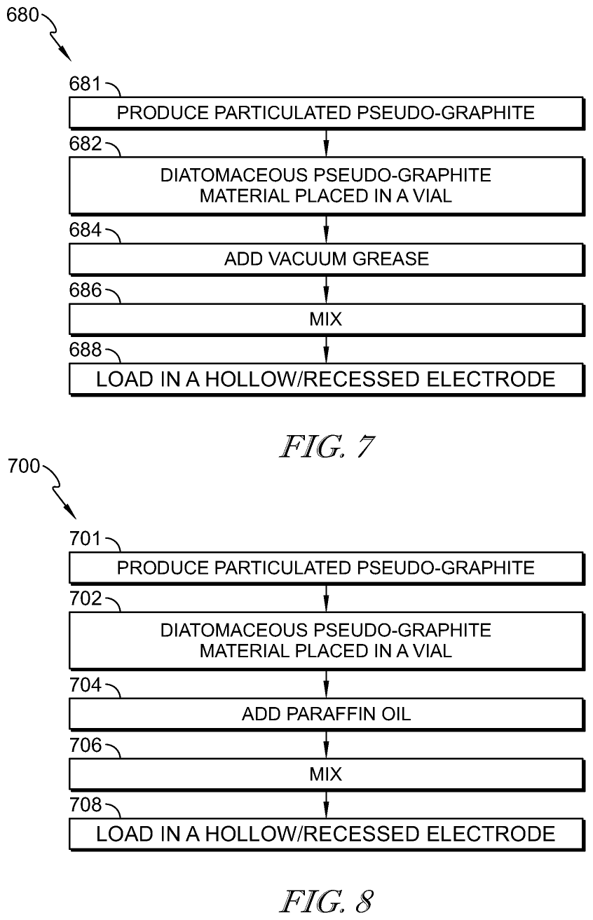

FIG. 7 illustrates a method 680 for a compositing process to produce diatomaceous pseudo-graphite material:Vacuum Grease=90:10 (by mass). At block 681, particulated pseudo-graphite is produced. At block 682, 45 mg diatomaceous pseudo-graphite material is placed in a vial. At block 684, 5 mg of vacuum grease is added. At block 686, the mixture is mixed for approximately 5 min. At block 688, the mixture is loaded in a hollow/recessed electrode.

FIG. 8 illustrates a method 700 for a compositing process to produce pseudo-graphite material coated K1 glass bubbles (3M):Paraffin oil=1:1 (by mass). At block 701, particulated pseudo-graphite is produced. At block 702, 50 mg of diatomaceous pseudo-graphite material is placed in a vial. At block 704, 50 mg of paraffin oil is added. At block 706, the mixture is mixed for approximately 5 min. At block 708, the mixture is loaded in a hollow/recessed electrode.

FIG. 9 illustrates a method 720 for a compositing process to produce pseudo-graphite material+Nafion with entrained porosity. At block 721, particulated pseudo-graphite is produced and 25 mg of particulated pseudo-graphite material is placed in a vial. At block 722, 75 μL of Nafion (5.0 wt %) is added to the pseudo-graphite material. At block 724, 10 mg Na₂SO₄ nanowires are added to the mixture. In some embodiments, these nanowires may have an aspect ratio of approximately 10:1 or greater. In some embodiments, these nanowires may have dimensions of approximately 100 nm in diameter and 5 μm in length. At block 726, 50 μL 25:75 mixture of Ethylene Glycol+EtOH is added. At block 728, the mixture is sonicated for approximately 5 min in a bath sonicator. At block 730, 5 μL of the suspension is injected on a glassy carbon electrode and dried. At block 732, the electrode is rinsed with DI-water to leach Na₂SO₄ nanowires while leaving behind a composite electrode with controlled, interconnected porosity.

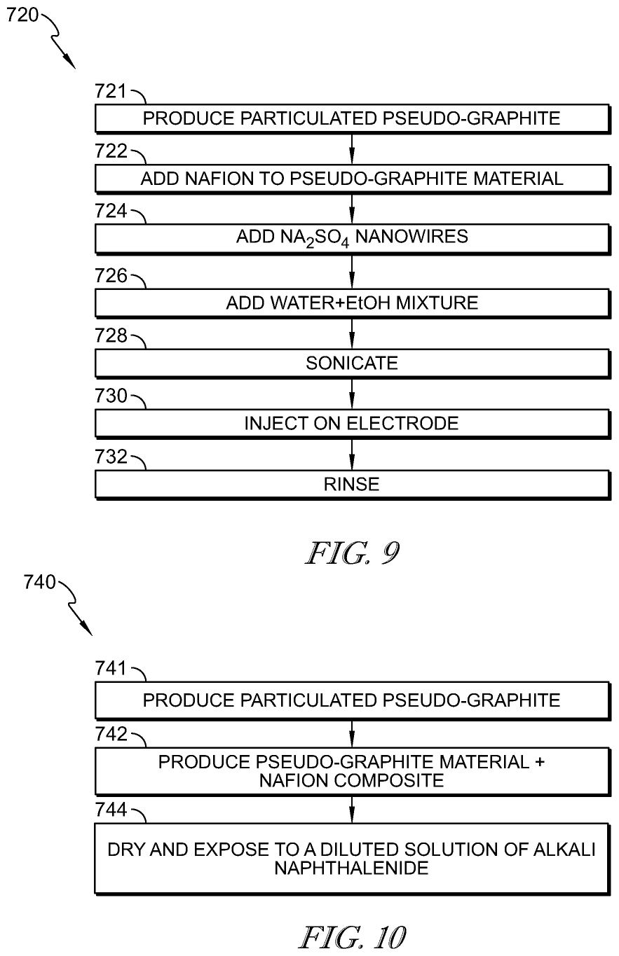

FIG. 10 illustrates a method 740 for a compositing process to produce pseudo-graphite material+Nafion with reductive modification. At block 741, particulated pseudo-graphite is produced. At block 742 the pseudo-graphite material+Nafion composite is produced as described above. At block 744, the pseudo-graphite material+Nafion composite is dried and is exposed to a diluted solution of alkali naphthalenide in ethereal solvent with treatment conditions chosen to be at a sufficient level and duration to remove some fraction of the fluorine content of the Nafion. In some embodiments, a relatively small fraction, for example, less than 10% or less than 5% of the fluorine content is removed. This provides the formation of additional carbon-carbon bonds in the system to cross-link and stabilize the composite structure.

FIG. 11 illustrates a method 760 for a compositing process to produce pseudo-graphite material+Teflon AF+polyethylene oxide for composites with ion conductive channels. At block 761, particulated pseudo-graphite is produced. At block 762, particulated pseudo-graphite material is added to a solution of Teflon-AF and polyethylene oxide in a mixture of Fluorinert FC-70 and Zonyl FSO. At block 764, the composition is mixed and sonicated to mix and suspend. At block 766, the suspension is deposited onto a substrate and dried. At block 768, the composite is annealed at a temperature of approximately 90 Celsius in an atmosphere saturated with water vapor for approximately 10 hours.

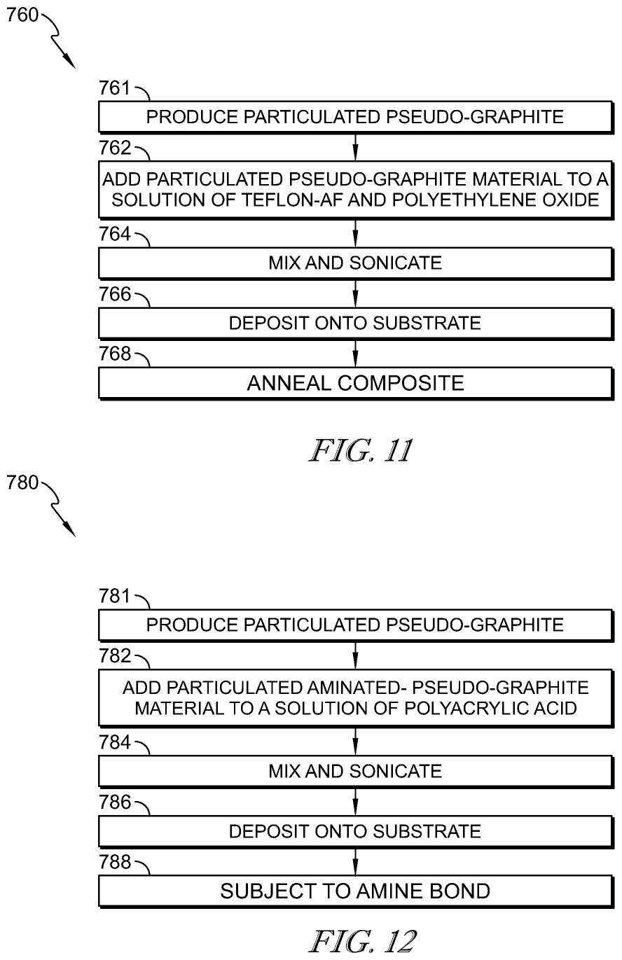

FIG. 12 illustrates a method 780 for a compositing process to produce aminated pseudo-graphite material+polyacrylic Acid with amide linkages. At block 781, particulated pseudo-graphite is produced. At block 782, particulated aminated-pseudo-graphite material is added to a solution of polyacrylic acid in DI-water. At block 784, the composition is mixed and sonicated to mix and suspend. At block 786, the suspension is deposited onto a substrate and dried. At block 788, the suspension is subjected to amide bond forming conditions, for example, drying at elevated temperature at reduced pressure/reduced humidity. In one embodiment, this may be carried out by maintaining the composite electrode at 140 Celcius for 12 hours under vacuum.

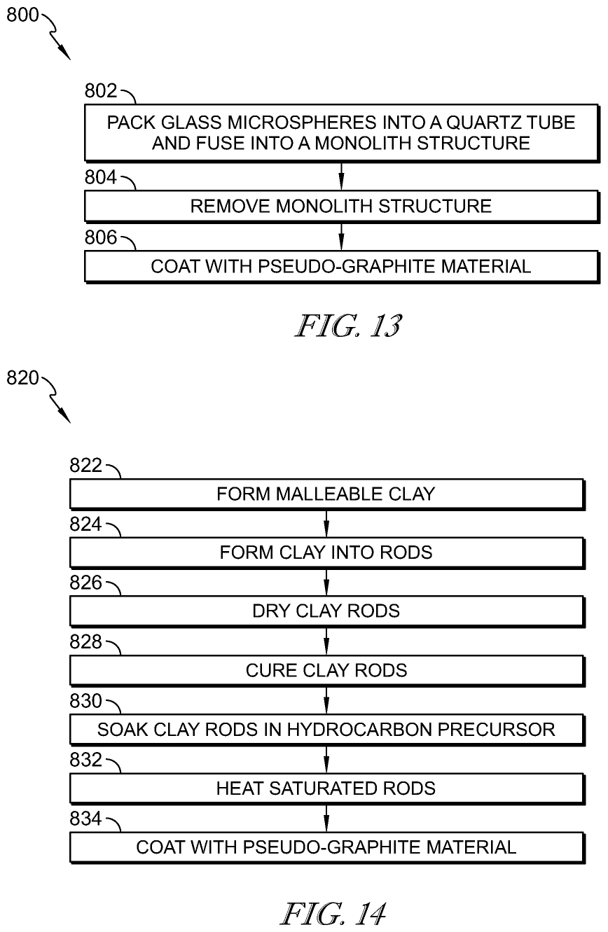

FIG. 13 illustrates a method 800 for a compositing process to produce porous fused glass pseudo-graphite material monolith electrode (binderless). At block 802, 3M glass microspheres (iM30K, S38, K25) are packed into a quartz tube (8 mm diameter) and fused into a monolith structure at 900 Celsius using a tube furnace. At block 804, the fused glass monoliths are removed from the outer quartz tube and polished to a uniform shape. At block 806, the uniform rods are coated with pseudo-graphite material using chemical vapor deposition.

FIG. 14 illustrates a method 820 for a compositing process to produce halloysite clay pseudo-graphite material monolith electrode (binderless). At block 822, halloysite clay made by introducing water to bare halloysite powder, and mixing until a malleable clay is formed. In some embodiments, carbon fiber may be mixed into the halloysite powder to increase the electrical conductivity of the resulting clay and final composite. At block 824, the clay is formed into parts of desired size and shape, for example, rods of 3 to 4 mm in diameter and 5 cm in length. At block 826, the clay is allowed to dry at room temperature, then in a glass drying oven until moisture free. At block 828, the dry clay rods are cured in a tube furnace at approximately 900 degrees Celsius for approximately 1 hour then removed and cooled down to room temperature. This curing should be performed in an inert atmosphere if the carbon fibers are incorporated into the part. At block 830, the cured rods are soaked in the hydrocarbon precursor until saturated. At block 832, the saturated rods are placed in the cold tube furnace under nitrogen, and brought up to approximately 900 degrees Celsius. At block 834, the rods are coated with pseudo-graphite material using chemical vapor deposition.

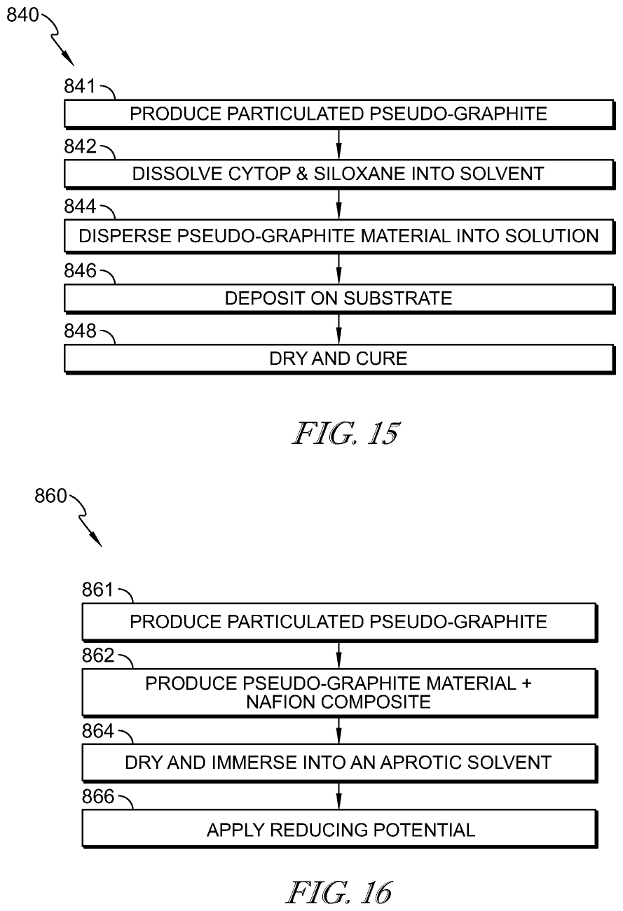

FIG. 15 illustrates a method 840 for a compositing process to produce pseudo-graphite material+CYTOP+silicon oxide. At block 841, particulated pseudo-graphite is produced. At block 842, CYTOP & hexachlorodisilane are dissolved into solvent CT-Solv180. At block 844, particulated pseudo-graphite material is dispersed into the solution of CYTOP:hexachlorodisilane. At block 846, the resulting dispersion is deposited onto a substrate, e.g. glassy carbon. At block 848, the substrate is dried and cured at approximately 80 degrees C. in the presence of moisture to convert hexachlorodisilane to silicate.

FIG. 16 illustrates a method 860 for a compositing process to produce pseudo-graphite material+Nafion with electrochemical reductive crosslinking. At block 861, particulated pseudo-graphite is produced. At block 862, pseudo-graphite material+Nafion composite is produced as described above. At block 864, the pseudo-graphite material+Nafion composite is dried and immersed into an aprotic solvent with supporting electrolyte, e.g. dried, degassed acetonitrile with tetrabutylammonium perchlorate. At block 866, a reducing potential is applied to the composite electrode at a sufficient level and duration to remove some fraction of the fluorine content of the Nafion. In some embodiments, less than 10% or less than 5% of the fluorine content is removed. This will provide the formation of additional bonds in the system to cross-link and stabilize the composite structure.

In other embodiments, a compositing process may be used to produce pseudo-graphite material+CYTOP+laser post-treatment, pseudo-graphite material+Nafion+Ag:AgCl, pseudo-graphite material+a silicon oxide precursor, pseudo-graphite material+Nafion+a ferrocene derivative, pseudo-graphite material+binder+a blowing agent, pseudo-graphite material+Nanocellulose or other oxidizable binders, pseudo-graphite material+grease, pseudo-graphite material+Nafion+PPy nanowires, or a film of Nafion over a pseudo-graphite material surface.

Pseudo-graphite material-based composite electrodes may be utilized for electrochemical applications such as sensors, water treatment, energy production, energy storage, etc. The use of composite pseudo-graphite material-based electrodes enables several cost efficiencies in the typical production of such electrodes and enables further functionality to be incorporated into these electrodes. Particulated pseudo-graphite composite electrodes may be used to reduce the propensity of the electrode to undergo surface exfoliation processes during certain electrochemical treatments. Particulated pseudo-graphite material materials may be produced at significantly lower cost-per-electrode than direct-on-substrate grown pseudo-graphite material electrodes. Deposited electrode methods may provide electrodes on substrates at significantly lower cost than having to grow the pseudo-graphite material directly onto a substrate and can use lower cost types of substrates.

Specific electrochemical functionalities enabled by pseudo-graphite materials include providing species-selective interactions, e.g. using Nafion for ion-selective transport, providing stabilization of species within the composite electrode, e.g. encapsulation of nanoparticles, and providing a hosting reservoir for functionality-active species, e.g. for ferrocenic compounds dissolved into the composite electrode, such as Nafion.

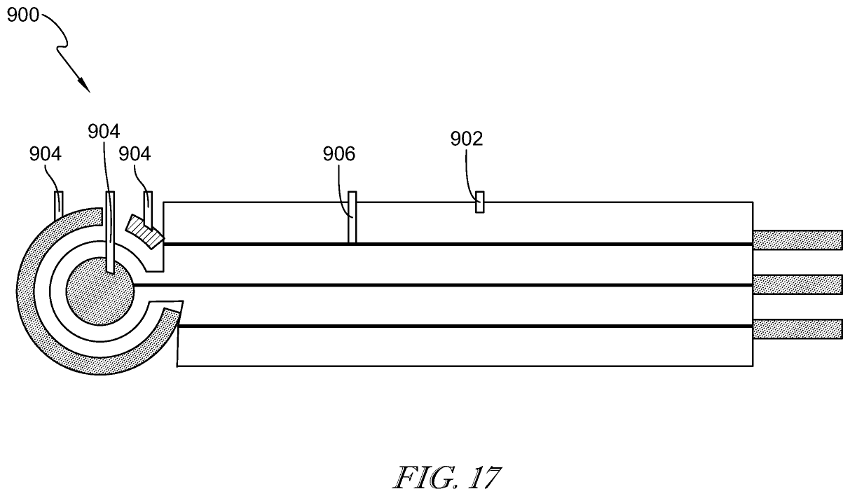

Referring to FIG. 17, an electrochemical device 900 includes pseudo-graphite materials deposited onto a non-conducting substrate 902 to form electrodes 904 and traces 906. In some embodiments, the pseudo-graphite material is screen-printed onto the substrate 902. In some embodiments, the traces 906 and electrodes 904 are formed entirely of the pseudo-graphite material and are not supported on an underlying conductive electrode. In some embodiments, some of the electrodes 904 are formed from pseudo-graphite composites and some electrodes 904 are formed from other materials, e.g. gold. In some embodiments, some of the traces 906 are formed from pseudo-graphite composites and some of the traces 906 are formed from other materials, e.g. gold.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the methods, systems, and articles described herein. It will be noted that alternative embodiments of the methods, systems, and articles of the present disclosure may not include all of the features described yet still benefit from at least some of the advantages of such features. Those of ordinary skill in the art may readily devise their own implementations of the methods, systems, and articles that incorporate one or more of the features of the present disclosure.

1. A method comprising:
forming a composite material comprising pseudo-graphite, and
depositing the composite material onto a surface of an electrode substrate to produce an electrode having a composite pseudo-graphite surface.

2. The method of claim 1, wherein the composite material is formed from particulated pseudo-graphite.

3. The method of claim 1, wherein forming the composite material comprises oxidizing the pseudo-graphite to form an oxidized composite material.

4. The method of claim 3, further comprising reducing the oxidized composite material.

5. The method of claim 1, wherein forming the composite material comprises forming at least one of aminated pseudo-graphite, carboxylated pseudo-graphite, methylated pseudo-graphite, alkylated pseudo-graphite, phenylated pseudo-graphite, benzylated pseudo-graphite, cyclopropenoid pseudo-graphite, carbene-oid derivatized pseudo-graphite, ferrocene-functionalized pseudo-graphite, and PEG-ylated pseudo-graphite.

6. The method of claim 1, wherein the composite material comprises a mixture of pseudo-graphite and a polymeric material.

7. The method of claim 1, wherein the composite material comprises a mixture of pseudo-graphite and a ceramic material.

8. The method of claim 1, wherein the composite material comprises a mixture of pseudo-graphite and a fluorinated polymeric material.

9. The method of claim 1, wherein the composite material comprises a mixture of pseudo-graphite, a secondary material, and a porosity-imparting material.

10. The method of claim 1, wherein the composite material comprises a mixture of pseudo-graphite and a silicon-containing material.

11. The method of claim 1, wherein the composite material comprises a mixture of pseudo-graphite and an oil material.

12. The method of claim 1, wherein the composite material comprises a mixture of pseudo-graphite and a conductive material.

13. The method of claim 1, further comprising modifying the pseudo-graphite through etherification.

14. The method of claim 1, further comprising modifying the pseudo-graphite through unsaturated pendant group binding.

15. The method of claim 1, further comprising modifying the pseudo-graphite through shell-functionalization.

16. The method of claim 1, further comprising modifying the pseudo-graphite through non-covalent decoration.

17. The method of claim 1, wherein forming the composite material comprises chemically linking a binder to the pseudo-graphite.

18. The method of claim 1, wherein depositing the composite material onto a surface of an electrode substrate comprises depositing the composite material onto a non-conducting substrate to form electrodes and traces.

19. The method of claim 18, wherein depositing the composite material onto a non-conducting substrate comprises screen-printing the composite material onto the non-conducting substrate.

20. An electrochemical device comprising:
a working electrode including a composite material comprising pseudo-graphite; and
an electrical source to supply at least one of a current or voltage to the working electrode.

21. The electrochemical device of claim 20, wherein the composite material has been formed through at least one of oxidation, etherification, unsaturated pendant group binding, shell-functionalization, or non-covalent decoration.

22. The electrochemical device of claim 20, wherein the composite material comprises at least one of aminated pseudo-graphite, carboxylated pseudo-graphite, methylated pseudo-graphite, alkylated pseudo-graphite, phenylated pseudo-graphite, benzylated pseudo-graphite, pseudo-graphite modified by a diamond-like surface layer, cyclopropenoid pseudo-graphite, carbene-oid derivatized pseudo-graphite, ferrocene pseudo-graphite, PEG-ylated pseudo-graphite, or functionalization rexn pseudo-graphite.

23. The electrochemical device of claim 20, wherein the composite material is formed from particulated pseudo-graphite.

24. The electrochemical device of claim 20, wherein the electrochemical device is a sensor further comprising a measurement circuit to measure a resultant signal from the working electrode.

25. The electrochemical device of claim 20, wherein the composite material comprises at least one of a mixture of pseudo-graphite and a polymeric material, a mixture of pseudo-graphite and a ceramic material, a mixture of pseudo-graphite and a fluorinated polymeric material, a mixture of pseudo-graphite and a silicon-containing material, a mixture of pseudo-graphite and an oil material, a mixture of pseudo-graphite and a grease material, a mixture of pseudo-graphite and an acid, a mixture of pseudo-graphite and a conductive material, or a mixture of pseudo-graphite, a secondary material, and a porosity-imparting material.
